(19) United States
(12) Patent Application Publication
(10) Pub. No.: US 2014/0208441 A1
(43) Pub. Date: Jul. 24, 2014

(54) Software Authentication

(71) Applicant: Ville Rantala, Mikkeli (FI)

(72) Inventor: Ville Rantala, Mikkeli (FI)

(73) Assignee: Nokia Corporation `, Espoo (FI)

(21) Appl. No.: 14/130,084

(22) PCT Filed: Jul. 1, 2011
(86) PCT No.: PCT/FI2011/050626

§ 371 Date: Mar. 17, 2014

(51) Int. Cl. G06F 21/44; H04L 29/06; G06F 21/12

(52) U.S. Cl. CPC G06F 21/44; G06F 21/121; H04L 63/061
USPC 726/29

(57) ABSTRACT

A method including: receiving a client application for distribution to user devices; receiving a secret authentication key associated with the client application; securing with digital rights management technology the secret authentication key associated with the client application; and providing an application package comprising the client application and the secured secret authentication key for distribution to user devices.

### TECHNICAL FIELD

The present invention generally relates to software authentication.

### BACKGROUND ART

Mobile devices, such as for example smart phones or tablet devices, may connect to remote servers over the Internet or other communication networks to provide services to users of the mobile devices.

In some cases, the device or the software of the device that connects to the remote server needs to be authenticated for security, privacy, rate limiting or other reasons. In this case the requests arriving at the remote server must contain identity of the device or software and some information to authenticate the identity. Without authentication, the identity can be easily spoofed, because the remote servers are open for connections in the Internet and anyone (any device) can send requests to them.

### SUMMARY

According to a first example aspect of the invention there is provided a method comprising:
receiving a client application for distribution to user devices;
receiving a secret authentication key associated with the client application;
securing with digital rights management technology the secret authentication key associated with the client application; and
providing an application package comprising the client application and the secured secret authentication key for distribution to user devices.

According to a second example aspect of the invention there is provided a method comprising:
providing for a client application to be distributed to users with a secret authentication key,
defining that the secret authentication key shall be secured with digital rights management technology;
receiving at a remote server a request from a client application;
accepting said request if the request is secured with said secret authentication key distributed with the client application; and
otherwise rejecting the request.

According to a third example aspect of the invention there is provided a method comprising:
at least one processor; and
at least one memory including computer program code;
the at least one memory and the computer program code configured to, with the at least one processor, cause the apparatus to:
receive a client application for distribution to user devices;
receive a secret authentication key associated with the client application;
secure with digital rights management technology the secret authentication key associated with the client application; and
provide an application package comprising the client application and the secured secret authentication key for distribution to user devices.

According to a fourth example aspect of the invention there is provided a method comprising:
at least one processor; and
at least one memory including computer program code;
the at least one memory and the computer program code configured to, with the at least one processor, cause the apparatus to:
provide for a client application to be distributed to users with a secret authentication key,
define that the secret authentication key shall be secured with digital rights management technology;
receive at a remote server a request from a client application;
accept said request if the request is secured with said secret authentication key distributed with the client application; and
otherwise reject the request.

According to a fifth example aspect of the invention there is provided a computer program embodied on a computer readable medium comprising computer executable program code which, when executed by at least one processor of an apparatus, causes the apparatus to perform:
receiving a client application for distribution to user devices;
receiving a secret authentication key associated with the client application;
securing with digital rights management technology the secret authentication key associated with the client application; and
providing an application package comprising the client application and the secured secret authentication key for distribution to user devices.

According to a sixth example aspect of the invention there is provided a computer program embodied on a computer readable medium comprising computer executable program code which, when executed by at least one processor of an apparatus, causes the apparatus to perform:
providing for a client application to be distributed to users with a secret authentication key,
defining that the secret authentication key shall be secured with digital rights management technology;
receiving at a remote server a request from a client application;
accepting said request if the request is secured with said secret authentication key distributed with the client application; and
otherwise rejecting the request.

According to yet another example aspect of the invention there is provided a memory medium embodying the computer program of the fifth or sixth example aspect.

Different non-binding example aspects of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well. Any appropriate combinations of the embodiments may be formed.

### BRIEF DESCRIPTION OF THE DRAWINGS

The invention will be described, by way of example only, with reference to the accompanying drawings, in which:

FIG. 1 shows a system according to an example embodiment;

FIG. 2A shows a flow chart according to an example embodiment;

FIG. 2B shows a flow chart according to another example embodiment;

FIG. 3 shows a flow chart according to yet another example embodiment;

FIG. 4 shows a block diagram of an apparatus according to an example embodiment.

### DETAILED DESCRIPTION

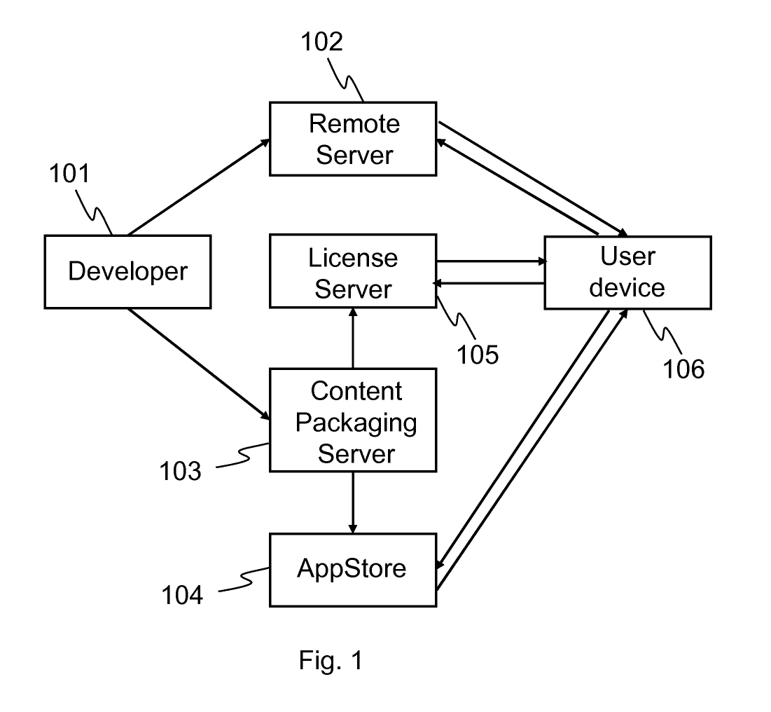

Example embodiments of the present invention and their potential advantages are understood by referring to FIGS. 1 through 4 of the drawings. In the following description, like numbers denote like elements.

Software or device authentication can be implemented using symmetric or asymmetric cryptography where the device possesses a private secret key that is used for the authentication. The problem is in delivering and securing the key so that it can't be read by anyone else, but the remote device or software in question.

There exists many protocols for remote authentication like Kerberos, but they all share the problem of delivering and securing the key that is used for the authentication. It is possible to embed a hardware-protected key to the device during manufacturing, but then the problem is to control who gets access to that key.

In an example embodiment of the invention digital rights management (DRM) technology is used to protect the delivery of the authentication keys. In an example embodiment the DRM technology that is used is such that it encrypts parts of the protected content and decrypts the encrypted parts in a DRM compatible target device. The decryption can be performed using hardware-protected keys, which are dedicated for the DRM usage. Additionally, a license granting rights to decrypt the content may be needed. One example of such technology is Microsoft® PlayReady®.

In an example embodiment the same technology and infrastructure that enables DRM is used to protect delivery of authentication keys and to securely store the authentication keys in the target device. The authentication keys can be delivered along with other DRM protected content. That is, the existing DRM solutions are used for a new purpose and in a new inventive way. The original purpose of DRM is to limit the use of digital content, but in embodiments of the invention the use of DRM is extended to remote device or software authentication.

The PlayReady® DRM technology mentioned above is one example of DRM technologies that may be employed in implementation of embodiments of the invention but in general the embodiments of the invention are not limited to a specific DRM technology.

FIG. 1 shows a system according to an example embodiment. The system comprises a developer 101 that develops applications and services, a remote server 102, a content packaging server 103, a license server 105 and an application store (AppStore) 104. Further the system comprises a user device 106 of a user who may use the device 106 for running applications and accessing services provided by the developer 101. The remote server 102 is configured to provide services to user devices. The content packaging server 103, license server 105 and AppStore 104 are used for protecting content according to DRM technology and for distributing applications to users.

In an example embodiment the following is performed for example by the developer 101 in the system of FIG. 1:
providing for a client application to be distributed to users with a secret authentication key,
defining that the secret authentication key shall be secured with digital rights management technology;
receiving at a remote server a request from a client application;
accepting said request if the request is secured with said secret authentication key distributed with the client application; and
otherwise rejecting the request.

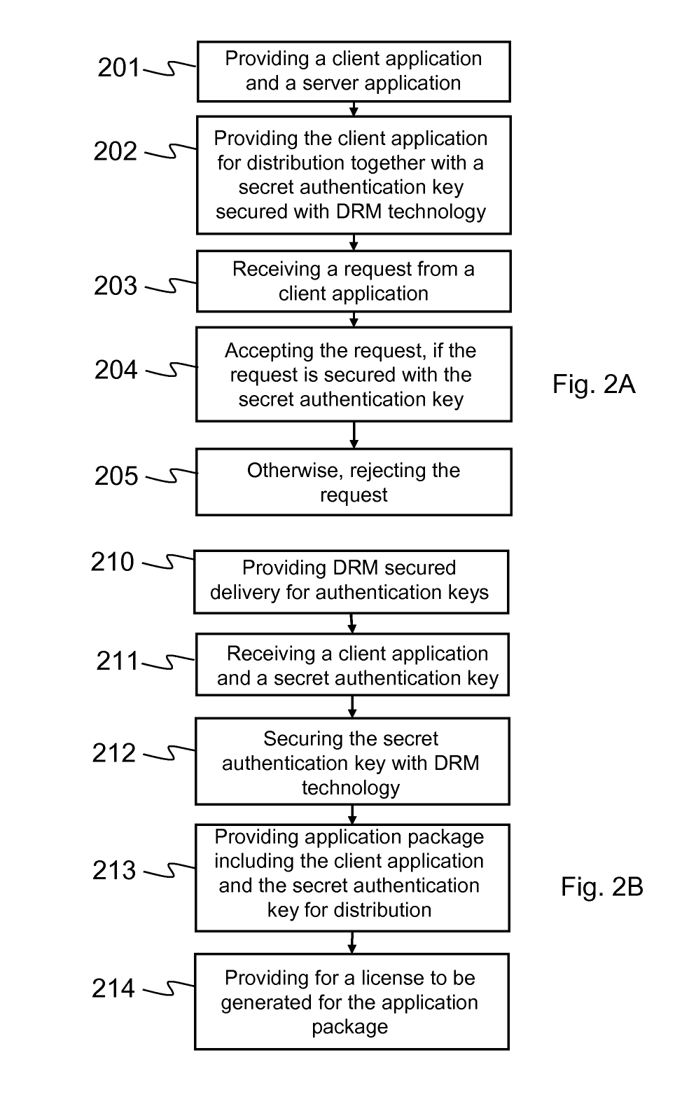

FIG. 2A shows a flow chart according to an example embodiment. The embodiment may be implemented for example by the developer 101 in the system of FIG. 1.

In phase 201, the developer publishes a new service. The service is implemented by means of a client application and a server application intended for communicating with the client application. The developer defines also a secret authentication key to be used for communications between the client application and the server application. The server application is uploaded into the remote server 102. Information about the secret authentication key is provided to the remote server 102, too.

In phase 202, the client application is provided for distribution to the content packaging server 103. It is defined that the application package is to be distributed together with the secret authentication key and the secret authentication key is to be secured with DRM technology. Additionally, it may be defined that also the client application or parts of the client application shall be DRM protected.

Later, in phase 203, a request or a connection attempt arrives at the remote server from a client application.

In phase 204, the request is accepted as a valid request, if the request is secured (signed or encrypted) with the secret authentication key. As the request is signed with the secret authentication key, the remote server knows that the request is coming from a client application published by the developer in phase 201. The remote server may additionally conclude that the request is coming from a device supporting DRM technology and containing the keys to decrypt DRM protected content. Otherwise, the request is rejected in phase 205. That is, requests and connection attempts not secured with the secret authentication key are rejected.

In an example embodiment the following is performed for example by the content packaging server 103 in the system of FIG. 1:
receiving a client application for distribution to user devices;
receiving a secret authentication key associated with the client application;
securing with digital rights management technology the secret authentication key associated with the client application; and
providing an application package comprising the client application and the secured secret authentication key for distribution to user devices.

FIG. 2B shows a flow chart according to another example embodiment. The embodiment may be implemented for example in the content packaging server 103 in the system of FIG. 1.

In phase 210, a service interface is provided for application developers. The service interface provides a possibility to define DRM secured delivery for authentication keys associated with applications.

In phase 211, a client application and a secret authentication key associated with the client application are received at the content packaging server 103.

In phase 212, the secret authentication key is secured with DRM technology. At the same time also the client application or part of the client application can be secured with the DRM technology, but this is not mandatory in view of operation of embodiments of the invention. In phase 213, an application package comprising the client application and the secured secret authentication key is provided for distribution to users. The application package is provided for example to the AppStore 104 from where the users can download the application. The application package can be downloaded e.g. to the user device 106 over the Internet.

In phase 214, the content packaging server 103 provides for a license associated with the client application package being generated in the license server 105. The license will define how and when the client application and/or the secret authentication key may be used and which entities have access to them. In an embodiment of the invention the license defines that only the client application will have access to the secret authentication key. It must be noted that the license generation and details of the license may vary depending on the DRM technology that is used and that in all embodiment of the invention the license is not necessarily mandatory.

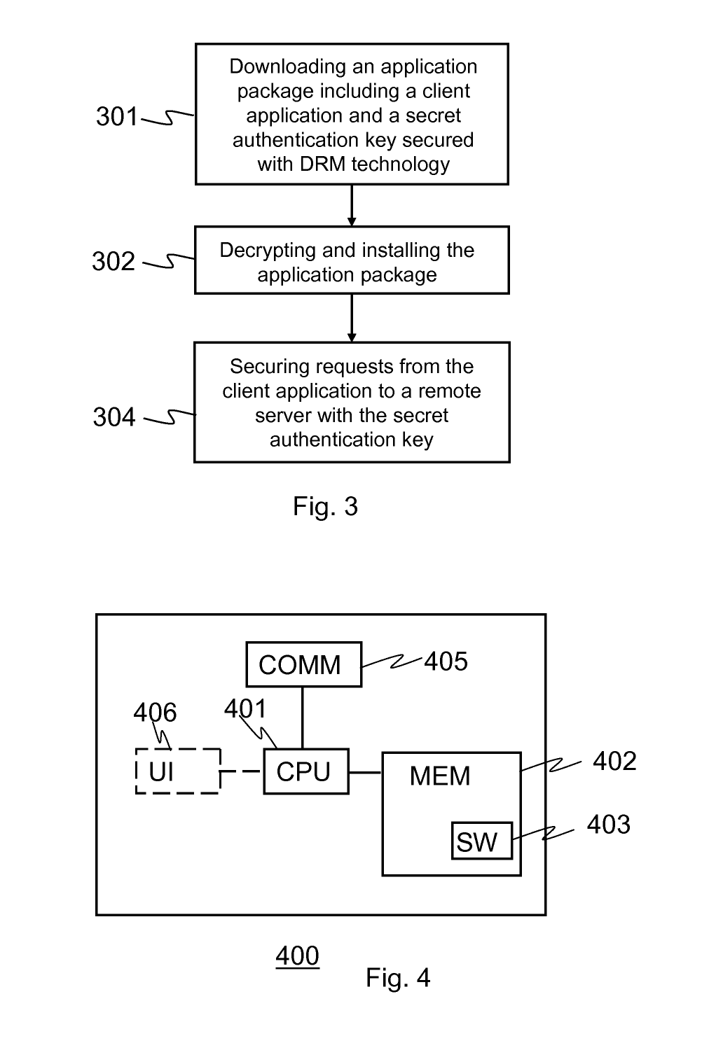

FIG. 3 shows a flow chart according to an example embodiment. The embodiment may be implemented for example in the user device 106 of the system of FIG. 1.

In phase 301, an application package including a client application and a secret authentication key secured with DRM technology is downloaded into the user device.

In phase 302, the application package is decrypted using keys of the DRM system and the application package is installed. The keys of the DRM system may be hardware-protected keys stored in the device. In order to be able the decrypt the application package, the user device 106 may need to interact with the license server 105, too, but this is a detail that depends on the DRM technology implementation that is used. While decrypting the application package also the secret authentication key is decrypted. In other words, the application package is handled the same way as other DRM protected content.

The DRM technology automatically provides that only the client application has access to the secret authentication key. In an example, any code or entity that is not part of the application package is not allowed to access the code of the application package.

Then, whenever the client application connects to or sends a request to a remote server, the request is secured with the secret authentication key in phase 304.

It must be noted that a specific implementation of an embodiment of the invention does not necessarily require all phases of FIG. 2A, 2B or 3 to be performed. Instead, some phases are optional.

In the following an example use case is discussed. In this example a service like Foursquare takes advantage of an embodiment of the invention. Foursquare provides a service that is based on user check-ins in physical locations. An example business model on top of the Foursquare service is a café, which offers a free cup of coffee after every ten check-ins to that café. A possible way to abuse such system is to create a script that would spoof the location of the user and create fake check-ins even if the user is not physically in the café.

By employing an embodiment of the invention, Foursquare can include in their client application package an authentication key that needs to be used for signing requests to their check-in API and securely deliver the authentication key together with the client application. The DRM technology takes care of that only the authentic Foursquare client application in the end user device is allowed access the authentication key and thereby to provide a valid check-in request to the service.

Then when a request that is secured with the authentication key would come in, the Foursquare server application would know that it was sent by an authentic Foursquare client application and thereby the request was coming from an actual position-enabled device. Because the DRM technology takes care of the integrity of the client application, Foursquare server application would know that the location sent to the API was queried from the device and not spoofed by an abuser of the system.

Embodiments of the present invention may be implemented in software, hardware, application logic or a combination of software, hardware and/or application logic. The software, application logic and/or hardware may reside on a communication apparatus (such as the user equipment 106 of FIG. 1) or on one or more servers (such as the remote server 102 of FIG. 1).

In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 4 below. The computer-readable medium may be a digital data storage such as a data disc or diskette, optical storage, magnetic storage, holographic storage, phase-change storage (PCM) or opto-magnetic storage. The computer-readable medium may be formed into a device without other substantial functions than storing memory or it may be formed as part of a device with other functions, including but not limited to a memory of a computer, a chip set, and a sub assembly of an electronic device.

FIG. 4 shows an example block diagram of an apparatus 400 according to certain example embodiments of the invention. The apparatus 400 is suitable for functioning as the user device 106 or the remote server 102 of FIG. 1, for example. It may be a handheld wireless apparatus, such as a mobile phone, smart phone or tablet device for example, or a computer or server configured for a specific purpose.

The apparatus 400 is a physically tangible object and comprises at least one memory 402 configured to store computer program code (or software) 403. The apparatus 400 further comprises at least one processor 401 configured to control the operation of the apparatus 400 using the computer program code 403, and a communication unit 405 configured to communicate with other entities or apparatuses. Additionally, the apparatus may comprise a user interface 406 (shown with dashed line). The user interface typically includes a display and keyboard or keypad for user interaction. It is not mandatory to have the user interface for the operation of embodiments of invention. Instead, controlling of the apparatus may be effected by means of a remote connection through the communication unit 405. The at least one processor 401 may be a master control unit (MCU). Alternatively, the at least one processor 401 may be a microprocessor, a digital signal processor (DSP), an application specific integrated circuit (ASIC), a field programmable gate array, a microcontroller or a combination of such elements. FIG. 4 shows one processor 401, but the apparatus 400 may comprise a plurality of processors 401.

The communication unit 405 may be, e.g., a radio interface module, such as a WLAN, Bluetooth, GSM/GPRS, CDMA, WCDMA, or LTE radio module. Alternatively or additionally, communication unit 405 may comprise a hardwired communication interface, such as Ethernet connection. The communication unit 405 may be integrated into the apparatus 400 or into an adapter, card or the like that may be inserted into a suitable slot or port of the apparatus 400. The communication unit 405 may support one radio interface technology or a plurality of technologies. FIG. 4 shows one communication unit 405, but the apparatus 400 may comprise a plurality of communication units 405.

A skilled person appreciates that in addition to the elements shown in FIG. 4, the apparatus 400 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the apparatus 400 may comprise a disposable or rechargeable battery (not shown) for powering the apparatus 400 when external power if external power supply is not available.

As to the operations of the embodiments of the invention, when the computer program code 403 is executed by the at least one processor 401, this causes the apparatus 400 to implement operations according to an embodiment of the invention.

A technical effect provided by various embodiments of the invention is that software authentication can be implemented with minimal overhead. This effect is provided by the feature that if DRM technology is already used for content protection in user devices, no additional infrastructure is needed for implementing embodiments of the invention as all necessary components are already there for the content protection purposes.

Various embodiments have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention. It is also noted that the above embodiments are used merely to explain selected aspects or steps that may be utilized in implementations of the present invention. Some features may be presented only with reference to certain example embodiments of the invention. It should be appreciated that corresponding features may apply to other embodiments as well.

Furthermore, some of the features of the above-disclosed embodiments of this invention may be used to advantage without the corresponding use of other features. As such, the foregoing description shall be considered as merely illustrative of the principles of the present invention, and not in limitation thereof.

Hence, the scope of the invention is only restricted by the appended patent claims.

1-15. (canceled)

16. A method comprising:
receiving a client application for distribution to user devices;
receiving a secret authentication key associated with the client application;
securing with digital rights management technology the secret authentication key associated with the client application; and
providing an application package comprising the client application and the secured secret authentication key for distribution to user devices.

17. A method of claim 16, further comprising:
providing an interface offering digital rights management technology protected distribution for secret authentication keys associated with client applications.

18. A method of claim 16, further comprising:
providing for a license according to the digital rights management technology to be generated for the application package.

19. A method of claim 16, further comprising:
securing at least part of said client application with the digital rights management technology.

20. A method of claim 16, further comprising:
securing said client application with the digital rights management technology.

21. A method comprising:
providing for a client application to be distributed to users with a secret authentication key,
defining that the secret authentication key shall be secured with digital rights management technology;
receiving at a remote server a request from a client application;
accepting said request if the request is secured with said secret authentication key distributed with the client application; and
otherwise rejecting the request.

22. A method of claim 21, further comprising:
defining that the client application or at least part of the client application shall be secured with digital rights management technology.

23. An apparatus comprising:
at least one processor; and
at least one memory including computer program code;
the at least one memory and the computer program code configured to, with the at least one processor, cause the apparatus to:
receive a client application for distribution to user devices;
receive a secret authentication key associated with the client application;
secure with digital rights management technology the secret authentication key associated with the client application; and
provide an application package comprising the client application and the secured secret authentication key for distribution to user devices.

24. An apparatus of claim 23, wherein the at least one memory and the computer program code is further configured to, with the at least one processor, cause the apparatus to:
provide an interface offering digital rights management technology protected distribution for secret authentication keys associated with client applications.

25. An apparatus of claim 23, wherein the at least one memory and the computer program code is further configured to, with the at least one processor, cause the apparatus to:
providing for a license according to the digital rights management technology to be generated for the application package.

26. An apparatus of claims 23, wherein the at least one memory and the computer program code is further configured to, with the at least one processor, cause the apparatus to:
secure said client application or at least part of said client application with the digital rights management technology.

27. An apparatus comprising:
at least one processor; and
at least one memory including computer program code;
the at least one memory and the computer program code configured to, with the at least one processor, cause the apparatus to:
provide for a client application to be distributed to users with a secret authentication key,
define that the secret authentication key shall be secured with digital rights management technology;
receive at a remote server a request from a client application;
accept said request if the request is secured with said secret authentication key distributed with the client application; and
otherwise reject the request.

28. An apparatus of claim 27, wherein the at least one memory and the computer program code is further configured to, with the at least one processor, cause the apparatus to:
define that the client application or at least part of the client application shall be secured with digital rights management technology.

29. A computer program embodied on a computer readable medium comprising computer executable program code which, when executed by at least one processor of an apparatus, causes the apparatus to perform:
receiving a client application for distribution to user devices;
receiving a secret authentication key associated with the client application;
securing with digital rights management technology the secret authentication key associated with the client application; and
providing an application package comprising the client application and the secured secret authentication key for distribution to user devices.

30. A computer program embodied on a computer readable medium comprising computer executable program code which, when executed by at least one processor of an apparatus, causes the apparatus to perform:
providing for a client application to be distributed to users with a secret authentication key,
defining that the secret authentication key shall be secured with digital rights management technology;
receiving at a remote server a request from a client application;
accepting said request if the request is secured with said secret authentication key distributed with the client application; and
otherwise rejecting the request.
